(19) United States
(12) Patent Application Publication
(10) Pub. No.: US 2024/0429971 A1
(43) Pub. Date: Dec. 26, 2024

(54) SYSTEMS AND METHODS FOR OVER-THE-AIR INTERFEROMTER FOR USE IN COMMUNICATION SYSTEMS

(71) Applicant: Huawei Technologies Co., Ltd., Shenzhen (CN)

(72) Inventors: Ahmad Abu Al Haija, Kanata (CA); Mohammadhadi Baligh, Ottawa (CA)

(21) Appl. No.: 18/828,502

(22) Filed: Sep. 9, 2024

Related U.S. Application Data
(63) Continuation of application No. PCT/CN2022/080126, filed on Mar. 10, 2022.

(51) Int. Cl. H04B 7/04; H04B 17/318

(52) U.S. Cl. CPC H04B 7/04013; H04B 17/318

(57) ABSTRACT

Aspects of the present disclosure provide an over-the-air (OTA) interferometer that enables transmitting by a source and redirecting by a RIS, to a destination, one or more reference signals over multiple time-frequency resources. The time frequency resource may be time slots. In each time-frequency resource, phases of one or more reference signals may be modified. Signal strength measurements may be made at the destination during the multiple time-frequency resources and used to determine a phase difference between the reference signals received at the destination. Examples of different types of source and destination may be devices such as a base station, an access point, a transmit receive point (TRP) and user equipment (UE).

### CROSS-REFERENCE TO RELATED APPLICATION

The present application is a continuation of International Application No. PCT/CN2022/080126, filed on Mar. 10, 2022, the disclosure of which is hereby incorporated by reference in its entirety.

### TECHNICAL FIELD

The present disclosure relates generally to wireless communications, and in particular embodiments, use of an over-the-air (OTA) interferometer in a communication system.

### BACKGROUND

In some wireless communication systems, user equipments (UEs) wirelessly communicate with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

High frequency and subTHz communication have recently received heightened research interest as potentially being a key enabler for future wireless networks to meet requirements of high data rate and high bandwidth. Multi-port technology provides low-cost circuitry that may be utilized in both low and high frequency applications.

### SUMMARY

According to an aspect of the disclosure there is provided a method involving: transmitting, by a base station, first configuration information including: relative phase difference information to apply to a plurality of portions of a reconfigurable intelligent surface (RIS) during each of a plurality of time slots; during each of the plurality of time slots, transmitting, by the base station, reference signals that are redirected by the plurality of portions configured according to the first configuration information; receiving, by the base station, first measurement feedback information from a user equipment (UE) pertaining to the reference signals received at the UE after being redirected by the plurality of portions of the RIS over each of the plurality of time slots; and determining, by the base station, updated RIS configuration information for a beam transmitted by the base station and redirected by the RIS based in part on the first measurement feedback information.

In some embodiments, the first configuration includes at least one of: configuration information sent to the RIS for configuring the RIS; or configuration information sent to the UE for configuring the UE

In some embodiments, the first configuration information is the configuration information sent to the RIS and includes at least one of: phase shifts at RIS elements in different portions; a number of portions in the plurality of portions; a number of time slots in the plurality of time slots; and phase shift information for use in phase shifting at least one of the plurality of portions with respect to at least one other portion in each time slot.

In some embodiments, the first configuration information is the configuration information sent to the UE and includes at least one of: a number of time slots in the plurality of time slots; an indication of a type of reference signal transmitted by the base station; an indication of a type of measurement to make at the UE; an indication of a function to determine a phase difference estimate based on the measured reference signals; and an indication of a type of information to be sent by the UE as measurement feedback.

In some embodiments, the method further involves, prior to transmitting the first configuration information: transmitting, by the base station, third configuration information, the third configuration information including identification of a plurality of beams, each beam having an associated direction, and identification of reference signals on the plurality of beams; transmitting, by the base station, the reference signals on the plurality of beams; and receiving, by the base station, second measurement feedback information, the second measurement feedback information including measurement information pertaining to a channel on a link between the base station and the UE via redirection by the RIS or a channel on a link between the RIS and the UE, wherein the second measurement feedback information is used in part to determine the first configuration information.

In some embodiments, the first measurement feedback information includes one or more of: signal strength measurements of the reference signals in each of the plurality of time slots; a function based on signal strength measurements of the reference signals in each of the plurality of time slots; channel phases of the reference signals in each of the plurality of time slots; or phase difference information between the reference signals redirected by different RIS portions, determined based on signal strength measurements of the reference signals in each of the plurality of time slots or other combination of the received signals of the plurality of time slots.

In some embodiments, the method further involves transmitting, by the base station, the updated RIS configuration information to the RIS for redirecting data transmission.

In some embodiments, the method further involves receiving data that has been redirected by the RIS or transmitting data to be redirected by the RIS based on the updated RIS configuration information.

According to an aspect of the disclosure there is provided a device including a processor and a computer-readable medium. The computer-readable medium has stored thereon computer executable instructions that when executed cause the processor to perform a method consistent with the embodiment described above.

According to an aspect of the disclosure there is provided a method involving: receiving, by a UE, first configuration information for measuring a received reference signal and transmitting measurement feedback to a base station; during each of a plurality of time slots, receiving, by the UE, reference signals that are redirected by a plurality of portions of a RIS, wherein during the plurality of time slots there is a relative phase difference applied to the plurality of portions during each of the plurality of time slots; measuring, by the UE, signal strength of the reference signals received at the UE during each of the plurality of time slots; and transmitting, by the UE, first measurement feedback information to the base station, the first measurement feedback information based upon the measured signal strength of the reference signals received at the UE after being redirected by the plurality of portions over each of the plurality of time slots.

In some embodiments, the first configuration information includes at least one of: a number of portions in the plurality of portions; a number of time slots in the plurality of time slots; phase shift information to phase shift at least one of the plurality of portions with respect to at least one other portion in each time slot; an indication of the type of reference signal transmitted by the base station; an indication of what type of measurement to make at the UE; an indication of a function to determine a phase difference estimate at the UE based on the measured reference signals; and an indication of a type of information to be sent by the UE as measurement feedback.

In some embodiments, the method further involves, prior to receiving the first configuration information: receiving, by the UE, second configuration information, the second configuration information including identification of a plurality of beams, each beam having an associated direction, and identification of reference signals on the plurality of beams; receiving, by the UE, the reference signals on the plurality of beams; and transmitting, by the UE, second measurement feedback information, the second measurement feedback information including measurement information pertaining to a channel on a link between the UE and the base station via redirection by the RIS or a channel on a link between the RIS and the UE, wherein the second measurement feedback information is used in part to determine the first configuration information.

In some embodiments, the first measurement feedback information includes one or more of: signal strength measurements of the reference signals in each of the plurality of time slots; a function based on signal strength measurements of the reference signals in each of the plurality of time slots; channel phases of the reference signals in each of the plurality of time slots; or phase difference information between the reference signals redirected by different RIS portions, determined based on signal strength measurements of the reference signals in each of the plurality of time slots or other combination of the received signals of the plurality of time slots.

In some embodiments, the method further involves receiving data that has been redirected by the RIS or transmitting data to be redirected by the RIS based at least in part on the first measurement feedback information.

According to an aspect of the disclosure there is provided a device including a processor and a computer-readable medium. The computer-readable medium has stored thereon computer executable instructions that when executed cause the processor to perform a method consistent with the embodiment described above.

According to an aspect of the disclosure there is provided a method involving: transmitting, by a base station, first configuration information including: relative phase difference information to apply to each of at least two RISs during each of a plurality of time slots; during each of the plurality of time slots, transmitting, by the base station, reference signals that are redirected by the at least two RISs configured according to the first configuration information; receiving, by the base station, first measurement feedback information from a UE pertaining to the reference signals received at the UE after being redirected by the at least two RISs over each of the plurality of time slots; and determining, by the base station and based on the feedback measurements, updated RIS configuration information for one or more RISs such that signals transmitted by the base station are redirected by the at least two RISs and align coherently at the UE.

In some embodiments, the first configuration includes at least one of: configuration information sent to the at least two RISs for configuring the at least two RISs; or configuration information sent to the UE for configuring the UE.

In some embodiments, the first configuration information is the configuration information sent to the at least two RIS includes at least one of: phase shifts at RIS elements for each RIS; a number of RISs; a number of time slots in the plurality of time slots; and phase shift information for use in phase shifting at least one of the RIS with respect to at least one other RIS in each time slot.

In some embodiments, the first configuration information is the configuration information sent to the UE and includes at least one of: a number of time slots in the plurality of time slots; an indication of the type of reference signal transmitted by the base station; an indication of what type of measurement to make at the UE; an indication of a function to determine a phase difference estimate at the UE based on the measured reference signals; and an indication of a type of information to be sent by the UE as measurement feedback.

In some embodiments, the method further involves, prior to transmitting the first configuration information: transmitting, by the base station, third configuration information, the third configuration information including identification of a plurality of beams, each beam having an associated direction, and identification of reference signals on the plurality of beams; transmitting, by the base station, the reference signals on the plurality of beams; and receiving, by the base station, second measurement feedback information, the second measurement feedback information including measurement information pertaining to a channel on a link between the base station and the UE via redirection by the at least two RISs or a channel on a link between the at least two RISs and the UE.

In some embodiments, the first measurement feedback information includes one or more of: signal strength measurements of the reference signals in each of the plurality of time slots; a function based on signal strength measurements of the reference signals in each of the plurality of time slots; channel phases of the reference signals in each of the plurality of time slots; or phase difference information between the reference signals redirected by different RISs, which can be determined based on signal strength measurements of the reference signals in each of the plurality of time slots or other combination of the received signals of the plurality of time slots.

In some embodiments, the method further involves transmitting, by the base station, the updated RIS configuration information for configuring one or more RISs for data transmission.

In some embodiments, the method further involves receiving data that has been redirected by the at least two RISs or transmitting data to be redirected by the at least two RISs based on the updated RIS configuration information.

According to an aspect of the disclosure there is provided a device including a processor and a computer-readable medium. The computer-readable medium has stored thereon computer executable instructions that when executed cause the processor to perform a method consistent with the embodiment described above.

According to an aspect of the disclosure there is provided a method involving: receiving, by a UE, first configuration information for measuring a received reference signal and transmitting measurement feedback to a base station; during each of a plurality of time slots, receiving, by the UE, reference signals that are redirected by at least two RISs, wherein during the plurality of time slots there is a relative phase difference applied to each of the at least two RISs during each of the plurality of time slots; and measuring, by the UE, signal strength of the reference signals received at the UE during each of the plurality of time slots; and transmitting, by the UE, first measurement feedback information to a base station, the first measurement feedback information based upon the measured signal strength of the reference signals received at the UE after being redirected by the at least two RISs over each of the plurality of time slots, wherein the first measurement feedback information may be used in part to determine updated RIS configuration information such that signals transmitted by the base station are redirected by the at least two RISs and align coherently at the UE.

In some embodiments, the first configuration information includes at least one of: a number of RISs; a number of time slots in the plurality of time slots; phase shift information to phase shift at least one of the RIS with respect to at least one other RIS in each time slot; an indication of the type of reference signal transmitted by the base station; an indication of what type of measurement to make at the UE; an indication of a function to determine a phase difference estimate at the UE based on the measured reference signals; and an indication of a type of information to be sent by the UE as measurement feedback.

In some embodiments, the method further involves, prior to transmitting the first configuration information: receiving, by the UE, second configuration information, the second configuration information including identification of a plurality of beams, each beam having an associated direction, and identification of reference signals on the plurality of beams; receiving, by the UE, the reference signals on the plurality of beams; and transmitting, by the UE, second measurement feedback information, the second measurement feedback information including measurement information pertaining to a channel on a link between the UE and the base station via redirection by the at least two RISs or a channel on a link between the at least two RISs and the UE.

In some embodiments, the first measurement feedback information includes one or more of: signal strength measurements of the reference signals in each of the plurality of time slots; a function based on signal strength measurements of the reference signals in each of the plurality of time slots; channel phases of the reference signals in each of the plurality of time slots; or phase difference information between the reference signal redirected by different RISs, which can be determined based on signal strength measurements of the reference signals in each of the plurality of time slots or other combination of the received signals of the plurality of time slots.

In some embodiments, the method further involves receiving data that has been redirected by the at least two RISs or transmitting data to be redirected by the at least two RISs that have been configured based at least in part on the first measurement feedback information.

According to an aspect of the disclosure there is provided a device including a processor and a computer-readable medium. The computer-readable medium has stored thereon computer executable instructions that when executed cause the processor to perform a method consistent with the embodiment described above.

According to an aspect of the disclosure there is provided a method involving: transmitting, by a base station, first configuration information including: relative phase difference information to apply to a plurality of portions of a RIS during each of a plurality of time slots; and information for a UE to transmit reference signals to be redirected by a plurality of portions of an RIS; during each of the plurality of time slots, measuring, by the base station, reference signals that have been received at the base station after being redirected by the plurality of portions configured according to the configuration information; and determining, by the base station, updated RIS configuration information for a beam transmitted by the UE and redirected by the RIS based in part on the measured received reference signals.

In some embodiments, the first configuration includes at least one of: configuration information sent to the RIS for configuring the RIS; or configuration information sent to the UE for configuring the UE

In some embodiments, the first configuration information is the configuration information sent to the RIS includes at least one of: phase shifts at RIS elements in different portions; a number of portions in the plurality of portions; a number of time slots in the plurality of time slots; and phase shift information for use in phase shifting at least one of the plurality of portions with respect to at least one other portion in each time slot.

In some embodiments, the first configuration information is the configuration information sent to the UE and includes at least one of: a number of time slots in the plurality of time slots; and an indication of the type of reference signal transmitted by the UE.

In some embodiments, the method further involves, prior to transmitting the first configuration information: transmitting, by the base station, third configuration information, the third configuration information including identification of a plurality of beams, each beam having an associated direction, and identification of reference signals on the plurality of beams; measuring, by the BS, signal strengths of the reference signals received at the BS; and determining, by the base station and based on its measurements, measurement information pertaining to a channel on a link between the base station and the UE via redirection by the RIS or a channel on a link between the RIS and the UE. Such channel information help prepare the first configuration information.

In some embodiments, the method further involves, subsequent to the measuring reference signals, determining one or more of: signal strength measurements of the reference signals in each of the plurality of time slots; a function based on signal strength measurements of the reference signals in each of the plurality of time slots; channel phases of the reference signals in each of the plurality of time slots; or phase difference information between the reference signals redirected by different RISs, determined based on signal strength measurements of the reference signals in each of the plurality of time slots or other combination of the received signals of the plurality of time slots.

In some embodiments, the method further involves transmitting, by the base station, updated RIS configuration information for configuring the RIS for redirecting data transmissions

In some embodiments, the method further involves receiving data that has been redirected by the RIS or transmitting data to be redirected by the RIS based on the updated RIS configuration information.

According to an aspect of the disclosure there is provided a device including a processor and a computer-readable medium. The computer-readable medium has stored thereon computer executable instructions that when executed cause the processor to perform a method consistent with the embodiment described above.

According to an aspect of the disclosure there is provided a method involving: receiving, by a UE, first configuration information for transmitting a reference signal to be redirected by a plurality of portions of an RIS; and during each of a plurality of time slots, transmitting, by the UE, reference signals that are redirected by the plurality of portions of an RIS, wherein during the plurality of time slots there is a relative phase difference applied to the plurality of portions during each of the plurality of time slots.

In some embodiments, the first configuration information includes at least one of: a number of time slots in the plurality of time slots; and an indication of the type of reference signal transmitted by the UE.

In some embodiments, the method further involves, prior to receiving the first configuration information: receiving, by the UE, second configuration information, the second configuration information including identification of a plurality of beams, each beam having an associated direction, and identification of reference signals on the plurality of beams; and transmitting, by the UE, the reference signals on the plurality of beams.

In some embodiments, the method further involves receiving data that has been redirected by the RIS or transmitting data to be redirected by the RIS.

According to an aspect of the disclosure there is provided a device including a processor and a computer-readable medium. The computer-readable medium has stored thereon computer executable instructions that when executed cause the processor to perform a method consistent with the embodiment described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a 6 port interferometer having two inputs and four outputs.

FIG. 2 is a schematic diagram of a transmission channel between a source and destination in which a planar array of configurable elements is used to redirect signals according to an aspect of the disclosure.

FIG. 3A is a schematic diagram of a communication system in which embodiments of the disclosure may occur.

FIG. 3B is another schematic diagram of a communication system in which embodiments of the disclosure may occur.

FIG. 4A is a block diagram illustrating units or modules in a device in which embodiments of the disclosure may occur.

FIG. 4B is a block diagram of an example reconfigurable intelligent surfaces (RIS).

FIG. 5 is a block diagram illustrating units or modules in a device in which embodiments of the disclosure may occur.

FIG. 6 is a block diagram illustrating a relationship between a base station and a UE via an RIS for transmission of a signal according to an aspect of the disclosure.

FIG. 7A is a block diagram illustrating a phase relationship between two signals transmitted between a base station and a UE via separate portions of an RIS according to an aspect of the disclosure.

FIG. 7B is a schematic diagram illustrating how two portions of an RIS may redirect signals between a base station and a UE over four slots according to an aspect of the disclosure.

FIG. 7C illustrates an example of phase values applied to elements of a RIS when the RIS is divided into two portions during a first time slot shown in FIG. 7B.

FIG. 7D illustrates an example of phase values applied to elements of a RIS when the RIS is divided into two portions during a second time slot shown in FIG. 7B.

FIG. 8 a pair of graphical plots showing over-the-air (OTA) performance for angle of arrival estimation.

FIG. 9 is a schematic diagram illustrating how four portions of an RIS may redirect signals between a base station and a UE over two slots according to an aspect of the disclosure.

FIG. 10 is an example of a signaling flow diagram for signaling between a base station, a user equipment (UE), and a RIS for downlink reference signal transmission according to an aspect of the disclosure.

FIG. 11 is an example of a signaling flow diagram for signaling between a base station, a user equipment (UE), and a RIS for uplink reference signal transmission according to an aspect of the disclosure.

FIG. 12A is a schematic diagram illustrating how two RIS may redirect signals between a base station and a UE over four slots according to an aspect of the disclosure.

FIG. 12B is a diagram illustrating estimation of a phase difference between two RIS redirected signals according to aspects of the disclosure.

FIG. 13 is a block diagram illustrating how a signal from a source and a signal redirected by an RIS are coherently combined according to aspects of the disclosure.

FIG. 14 is a block diagram of a frequency selective channel with multiple narrow band RIS, each used for a different band according to aspects of the disclosure.

FIG. 15 is a block diagram of a relay channel using coherent relaying according to aspects of the disclosure.

### DETAILED DESCRIPTION OF THE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Generally, a multiport structure is a passive circuit that consists of couplers and/or power dividers connected by transmission lines and phase shifters. Some multiport structures are interferometers that are used to compare amplitude, phase or frequency between two signals via measured power readings.

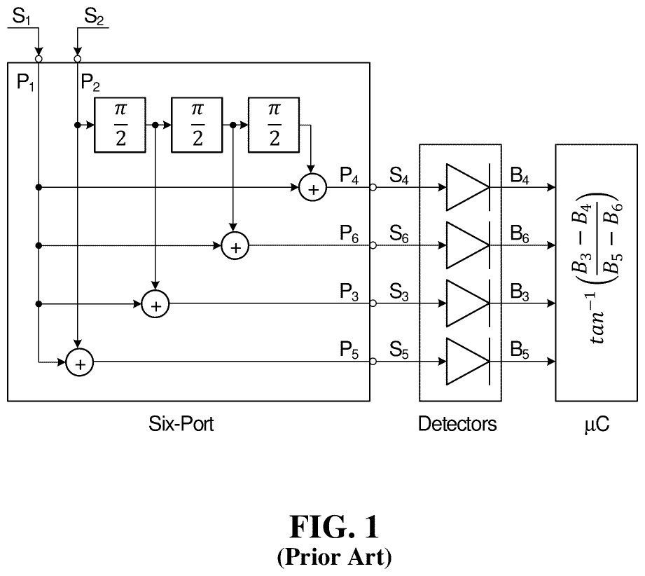

A 6-port interferometer is a common type of multiport structure. FIG. 1 illustrates an example of a 6-port interferometer that has two inputs S₁ and S₂ and four outputs S₃, S₄, S₅ and S₆ for a total of 6-ports. The 6-port interferometer compares the first input S₁ with different instances of the second input S₂ that have been phase shifted with respect to one another. For example, a first output S₃ is a result of superimposing the first input S₁ with the second input S₂, a second output S is a result of superimposing the first input S₁ with the second input S₂ that has been phase shifted by a first phase shifter by: π/2, a third output S₅ is a result of superimposing the first input S₁ with the second input S₂ that has been phase shifted by a total of by the first phase shifter and a second phase shift by another π/2, and a fourth output S₆ is a result of superimposing the first input S₁ with the second input S₂ that has been phase shifted by π total of 3π/2 by the first and second phase shifters and a third phase shift by another π/2. In the example of FIG. 1, four detectors are used to measure the power of the four superimposed signals from outputs S₃, S₄, S₅ and S₆ in the form of detected values B₃, B₄, B₅, and B₆. Based on these measurements, the phase difference between the two inputs S₁ and S₂ can be determined based on the expression

$$tan ϕ = \frac{{B}_{3} - {B}_{4}}{{B}_{5} - {B}_{6}} ,$$

for example by a microprocessor (μC).

As the interferometer and similar multiport devices include the functionality of adding controlled phase shifts to one or more signals, a possible technology that is capable of phase modification and may be used to implements the phase addition is a reconfigurable intelligent surface (RIS). The RIS consists of an array of elements that can change the phase (and also amplitude, polarization, or even the frequency) of an incident wave/signal. Such changes are achieved by configuring the RIS elements via bias voltages (or other methods like mechanical deformation and phase change materials), that are controlled by a control circuit connected to the RIS.

Because of low cost implementation and the ability to perform accurate measurements, devices such as the 6-port interferometer illustrated in FIG. 1 may be utilized for multiple different types of applications in telecommunication networks including, carrier frequency offset (CFO) estimation, phase noise measurements, localization and distance measurements, and modulation and demodulation techniques. Such devices are typically implemented in the form or a physical circuit structure in a transmitter, receiver or transceiver.

However, an interferometer such as the 6-port interferometer shown in FIG. 1 typically has a specific receiver structure regardless of how simple the design is. For example, to improve the performance of the 6-port interferometer, calibration may be needed for the detectors so that they have identical or substantially the same performance.

In an attempt to simplify operation at the receiver, aspects of the disclosure provide using interferometry by modifying transmission signals from active nodes, such as base station, access nodes or user equipment, to simplify the receiver circuit design. Implementation of an interferometer design according to aspects of the disclosure will be being referred to as an over-the-air (OTA) interferometer. The OTA may perform a similar functionality to that of a physical circuit design, but is applied to transmission signals between devices in a communication network over the air. Some embodiments of the disclosure include use of an RIS to enable a phase shift in the OTA between two signals transmitted between two active nodes. Some embodiments of the disclosure include use of a relay to enable a phase shift in the OTA between two signals transmitted between two active nodes. Some embodiments of the disclosure include use of OTA to enable coherent transmission between communication signals transmitted between two active nodes via multiple paths.

Aspects of the disclosure may also provide methods of signaling associated with the OTA interferometer for various different applications such as, but not limited to fine configuration at the RIS, e.g. fine estimation of an angle of arrival (AoA) and/or angle of departure (AoD) at the RIS, and coherent transmission for downlink (DL), uplink (UL), relaying, and multi-transmit receive point (TRP) transmission.

Controllable metasurfaces are referred to by different names such as reconfigurable intelligent surface (RIS), large intelligent surface (LIS), intelligent reflecting surface (IRS), digital controlled surface (DCS), intelligent passive mirrors, and artificial radio space. While in subsequent portions of this document RIS is used most frequently when referring to these metasurfaces, it is to be understood then this is for simplicity and is not indented to limit the disclosure.

A RIS can realize “smart radio environment” or “smart radio channel” i.e. the environment radio propagation properties can be controlled to realize personalized channel for desired communication. The RIS may be established among multiple base stations to produce large scale smart radio channels that serve multiple users. With a controllable environment, RISs may first sense environment information and then feeds the environment information that has been sensed back to the system. According to this information, the system may optimize transmission mode parameters and RIS parameters through smart radio channels, at one or more of the transmitter (whether the base station or a UE), the channel and the receiver (whether the UE or a base station).

Because of beamforming gains associated with RISs, exploiting smart radio channels may significantly improve one or more of link quality, system performance, cell coverage, and cell edge performance in wireless networks. Not all RIS panels use the same structure. Different RIS panels may be designed with different types of phase adjusting capabilities that range from continuous phase control to discrete control with multiple levels.

Another application of RISs is in transmitters that directly modulate incident radio one or more wave properties, such as phase, amplitude polarization and/or frequency without a need for active components as used in RF chains in traditional multiple input multiple output (MIMO) transmitters. RIS based transmitters have many merits, such as simple hardware architecture, low hardware complexity, low energy consumption and high spectral efficiency. Therefore, RISs provide a new direction for extremely simple transmitter design in future radio systems.

RIS assisted MIMO also may be used to assist fast beamforming with the use of accurate positioning, or to conquer blockage effects through channel state information (CSI) acquisition in mmWave systems. Alternatively, RIS assisted MIMO may be used in non-orthogonal multiple access (NOMA) in order to improve reliability at very low signal to noise ratio (SNR), accommodate more users and enable higher modulation schemes. RIS is also applicable to native physical security transmission, wireless power transfer or simultaneous data and wireless power transfer, and flexible holographic radios.

The ability to control the environment and network topology through strategic deployment of RISs, and other non-terrestrial and controllable nodes is an important paradigm shift in MIMO system, such as 6G MIMO. Such controllability is in contrast to the traditional communication paradigm, where transmitters and receivers adapt their communication methods to achieve the capacity predicted by information theory for the given wireless channel. Instead, by controlling the environment and network topology, MIMO aims to be able to change the wireless channel and adapt the network condition to increase the network capacity.

One way to control the environment is to adapt the topology of the network as user distribution and traffic patterns change over time. This involves utilizing high altitude pseudo satellites (HAPs), unmanned ariel vehicles (UAVs) and drones when and where it is necessary.

RIS-assisted MIMO utilizes RISs to enhance the MIMO performance by creating a smart radio channel. To extract full potential of RIS-assisted MIMO, a system architecture and more efficient scheme are provided in the present disclosure.

An RIS may include many small reflection elements, often comparable in size with the wavelength (for example, from 1/10 to a couple of wavelengths). Each element can be controlled independently. The control mechanism may be, for example, a bias voltage or a driving current to change the characteristics of the element. The combination of the control voltages for all elements (and hence the effective response) may be referred to as the RIS pattern. This RIS pattern may control the behavior of the RIS including at least one of the width, shape and direction of the beam, which is referred to as the beam pattern.

The controlling mechanism of the RIS often is through controlling the phase of a wavefront incident on the surface and reflected by the surface. Other techniques of controlling the RIS include attenuating reflection of the amplitude to reduce the reflected power and “switching off” the surface. Attenuating the power and switching off the surface can be realized by using only a portion of the RIS, or none of the RIS, for reflection while applying a random pattern to the rest of the panel, or a pattern that reflects the incident wavefront in a direction that is not in a desired direction.

In some portions of this disclosure, RIS may be referred to as a set of configurable elements arranged in a linear array or a planar array. Nevertheless, the analysis and discussions are extendable to two or three dimensional arrangements (e.g., circular array). A linear array is a vector of N configurable elements and a planar array is a matrix of N×M configurable elements, where N and M are non-zero integers. These configurable elements have the ability to redirect a wave/signal that is incident on the linear or planar array by changing the phase of the wave/signal. The configurable elements are also capable of changing the amplitude, polarization, or even the frequency of the wave/signal. In some planar arrays these changes occur as a result of changing bias voltages that control the individual configurable elements of the array via a control circuit connected to the linear or planar array. The control circuit that enables control of the linear or planar array may be connected to a communications network that base stations and UEs communicating with each other are part of. For example, the network that controls the base station may also provide configuration information to the linear or planar array. Control methods other than bias voltage control include, but are not limited to, mechanical deformation and phase change materials.

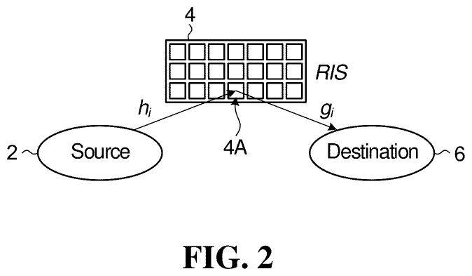

Because of their ability to manipulate the incident wave/signal, the low cost of these types of RIS, and because these types of RIS require small bias voltages, RIS have recently received heightened research interest in the area of wireless communication as a valuable tool for beamforming and/or modulating communication signals. A basic example for RIS utilization in beamforming is shown in FIG. 2 where each RIS configurable element 4a (unit cell) can change the phase of the incident wave from source such that the reflected waves from all of the RIS elements are aligned to the direction of the destination to increase or maximize its received signal strength (e.g. maximize the signal to noise ratio). Such a reflection via the RIS may be referred to as reflect-array beamforming. In some embodiments, the planar array of configurable elements, which may be referred to as an RIS panel, can be formed of multiple co-planar RIS sub-panels. In some embodiments, the RIS can be considered as an extension of the BS antennas or a type of distributed antenna. In some embodiments, the RIS can also be considered as a type of passive relay.

Some aspects of the present disclosure provide methods and device for utilizing RIS panels in the wireless network to take advantage of the RIS capabilities, intelligence, coordination and speed, and thereby propose solutions having different signaling details and capability requirements.

FIG. 2 illustrates an example of a planar array of configurable elements, labelled in the figure as RIS 4, in a channel between a source 2, or transmitter, and a destination 6, or receiver. The channel between the source 2 and destination 6 include a channel between the source 2 and RIS 4 identified as hi and a channel between the RIS 4 and destination 6 identified as gᵢ for the i^{th} RIS configurable element (configurable element 4a) where i∈{1,2,3, . . . , N*M} assuming the RIS consists of N*M elements or unit cells. A wave that leaves the source 2 and arrives at the RIS 4 can be said to be arriving with a particular AoA. When the wave is reflected or redirected by the RIS 4, the wave can be considered to be leaving the RIS 4 with a particular AoD. In some embodiments, the planar array of configurable elements, which may be referred to as an RIS panel, can be formed of multiple co-planar RIS sub-panels. In some embodiments, the RIS can be considered as an extension of the BS antennas or a type of distributed antenna. In some embodiments, the RIS can also be considered as a type of passive relay.

While FIG. 2 has two dimensional planar array RIS 4 and shows a channel hi and a channel gᵢ, the figure does not explicitly show an elevation angle and azimuth angle of the transmission from the source 2 to RIS 4 and the elevation angle and azimuth angle of the redirected transmission from the RIS 4 to the destination 6. In the case of a linear array, there may be only one angle to be concerned about, i.e. the azimuth angle.

In wireless communications, the RIS 4 can be deployed as 1) a reflector between a transmitter and a receiver, as shown in FIG. 2, or as 2) a transmitter (integrated at the transmitter) to help implement a virtual MIMO system as the RIS helps to direct the signal from a feeding antenna.

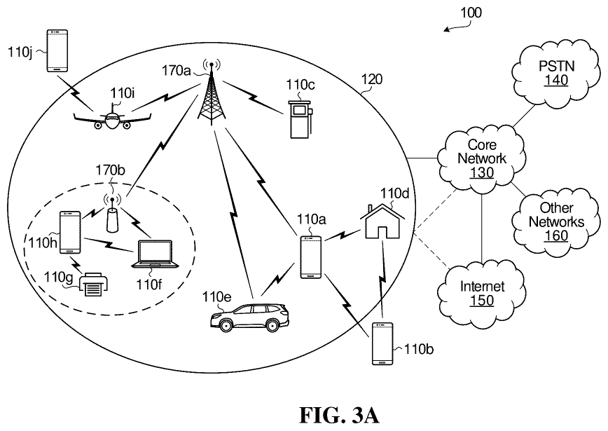

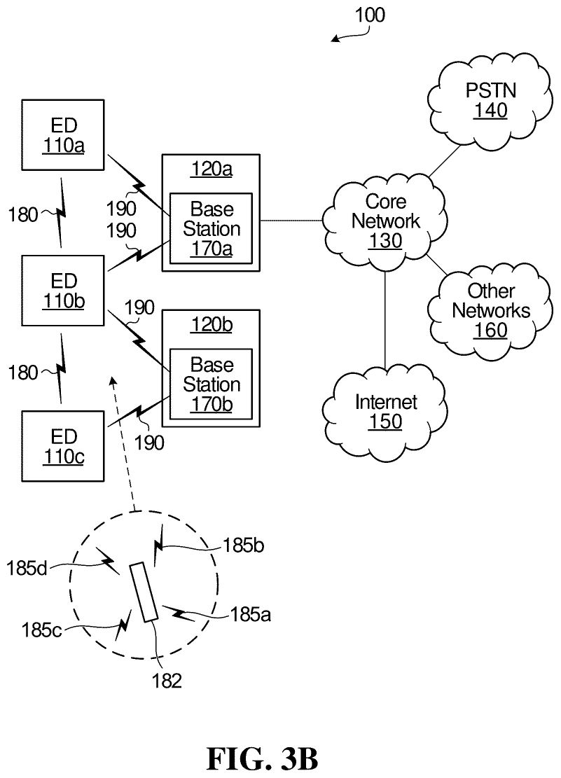

FIGS. 3A, 3B, 4A and 4B following below provide context for the network and device that may be in the network and that may implement aspects of the present disclosure.

Referring to FIG. 3A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 3B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 3B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 3B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 3B, any reasonable number of these components or elements may be included in the communication system 100.

The EDs 110a-110c are configured to operate, communicate, or both, in the communication system 100. For example, the EDs 110a-110c are configured to transmit, receive, or both, via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 3B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 170a-170b may be a non-terrestrial base station that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110c may be alternatively or additionally configured to interface, access, or communicate with any other base station 170a-170b, the internet 150, the core network 130, the PSTN 140, the other networks 160, or any combination of the preceding.

The EDs 110a-110c and base stations 170a-170b are examples of communication equipment that can be configured to implement some or all of the operations and/or embodiments described herein. In the embodiment shown in FIG. 3B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110c communicate with one another over one or more sidelink (SL) air interfaces 180 using wireless communication links e.g. radio frequency (RF), microwave, infrared (IR), etc. The SL air interfaces 180 may utilize any suitable radio access technology, and may be substantially similar to the air interfaces 190 over which the EDs 110a-110c communication with one or more of the base stations 170a-170c, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 180. In some embodiments, the SL air interfaces 180 may be, at least in part, implemented over unlicensed spectrum.

In addition, some or all of the EDs 110a-110c may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110c may be multimode devices capable of operation according to multiple radio access technologies, and incorporate multiple transceivers necessary to support multiple radio access technologies.

Also shown in FIG. 3B is a RIS 182 located within the serving area of base station 170b. A first signal 185a is shown between the base station 170b and the RIS 182 and a second signal 185b is shown between the RIS 182 and the ED 110b, illustrating how the RIS 182 might be located within the uplink or downlink channel between the base station 170b and the ED 110b. Also shown is a third signal 185c between the ED 110c and the RIS 182 and a fourth signal 185d is shown between the RIS 182 and the ED 110b, illustrating how the RIS 182 might be located within the SL channel between the ED 110c and the ED 110b.

While only one RIS 182 is shown in FIG. 3B, it is to be understood that any number of RIS could be included in a network.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 4A illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 4A, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 3A or 3B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 4A. FIG. 4A illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

While not shown in FIG. 4A, a RIS may be located between the ED 110 and the NT-TRP 172 or between the ED 110 and the T-TRP 170, in a similar manner as RIS 182 is shown between the EDs 110 and base station 170b in FIG. 3B. A RIS may be located between the NT-TRP 172 and the T-TRP 170 to aid in communication between the two TRPs.

Additional details regarding the EDs 110, T-TRP 170, and NT-TRP 172 are known to those of skill in the art. As such, these details are omitted here.

FIG. 4B illustrates an example RIS device that may implement the methods and teachings according to this disclosure. In particular, FIG. 4B illustrates an example RIS device 182. These components could be used in the system 100 shown in FIGS. 3A and 3B, the system shown in FIG. 4A, or in any other suitable system.

As shown in FIG. 4B, the RIS device 182, which may also be referred to as a RIS panel, includes a controller 293 that includes at least one processing unit 285, an interface 290, and a set of configurable elements 295. The set of configurable elements are arranged in a single row or a grid or more than one row, which collectively form the reflective surface of the RIS panel. The configurable elements can be individually addressed to alter the direction of a wavefront that impinges on each element. RIS reflection properties (such as beam direction, beam width, frequency shift, amplitude, and polarization) are controlled by RF wavefront manipulation that is controllable at the element level, for example via the bias voltage at each element to change the phase of the reflected wave. This control signal forms a pattern at the RIS. To change the RIS reflective or redirecting behavior, the RIS pattern needs to be changed.

Connections between the RIS and a UE can take several different forms. In some embodiments, the connection between the RIS and the UE is a reflective channel where a signal from the BS is reflected, or redirected, to the UE or a signal from the UE is reflected to the BS. In some embodiments, the connection between the RIS and the UE is a reflective connection with passive backscattering or modulation. In such embodiments a signal from the UE is reflected by the RIS, but the RIS modulates the signal by the use of a particular RIS patter. Likewise, a signal transmitted from the BS may be modulated by the RIS before it reaches the UE. In some embodiments, the connection between the RIS and the UE is a network controlled sidelink connection. This means that that the RIS may be perceived by the UE as another device like a UE, and the RIS forms a link similar to two UEs, which is scheduled by the network. In some embodiments, the connection between the RIS and the UE is an ad hoc in-band/out-of-band connection.

A RIS device, also referred to as a RIS panel, is generally considered to be the RIS and any electronics that may be used to control the configurable elements and hardware and/or software used to communication with other network nodes. However, the expressions RIS, RIS panel and RIS device may be used interchangeably in this disclosure to refer to the RIS device used in a communication system.

The processing unit 285 implements various processing operations of the RIS 182, such as receiving the configuration signal via interface 290 and providing the signal to the controller 293. The processing unit 285 could, for example, include a microprocessor, microcontroller, digital signal processor, field programmable gate array, or application specific integrated circuit.

While this is an example of an RIS, it should be understood that the RIS may take different forms and be implemented in different manner than shown in FIG. 4B. The RIS 182 ultimately needs a set of configurable elements that can be configured as described to operate herein.

FIG. 4B illustrates an interface 290 to receive configuration information from the network. In some embodiments, the interface 290 enables a wired connection to the network. The wired connection may be to a base station or some other network-side device. In some embodiments, the wired connection is a propriety link, i.e. a link that is specific to a particular vendor or supplier of the RIS equipment. In some embodiments, the wired connection is a standardized link, e.g. a link that is standardized such that anyone using the RIS uses the same signaling processes. The wired connection may be an optical fiber connection or metal cable connection.

In some embodiments, the interface 290 enables a wireless connection to the network. In some embodiments, the interface 290 may include a transceiver that enables RF communication with the BS or with the UE. In some embodiments, the wireless connection is an in-band propriety link. In some embodiments, the wireless connection is an in-band standardized link. The transceiver may operate out of band or using other types of radio access technology (RAT), such as Wi-Fi or BLUETOOTH. In some embodiments, the transceiver is used for low rate communication and/or control signaling with the base station. In some embodiments, the transceiver is an integrated transceiver such as an LTE, 5G, or 6G transceiver for low rate communication. In some embodiments, the interface could be used to connect a transceiver or sensor to the RIS.

Different types of RISs may be made from different types of materials and use different technologies. A non-limiting list of examples include liquid crystal based RIS, micro electro-mechanical mirror (MEM) based RIS, and graphene based RIS. As a result, different types of RISs may each have a different response time than other RISs.

In some embodiments, the RIS may be equipped with active RIS elements that enable a sensing functionality and/or a receive functionality. When the RIS has a sensing and/or receive functionality, the RIS may have a capability to provide information to the base station or UE related to beam management. For example, the RIS may be equipped with sensing elements that enable measuring of a signal strength of a signal impinging on the sensing elements and accordingly, the RIS provides guidance on which beam to use based on the measurements. In such cases, it is possible that the phases of individual elements of the RIS may be set according to information that is partially from the RIS itself, rather than depending solely on the communication from the BS and/or UE.

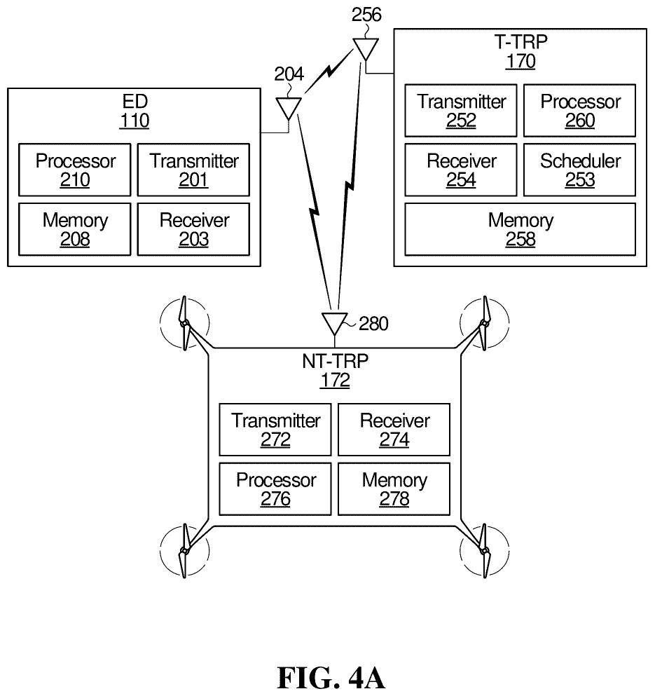

One or more steps of the embodiment methods provided herein may be performed by corresponding units or modules, according to FIG. 5. FIG. 5 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHZ, millimeter to Terahertz carrier frequency, from space, outdoor to indoor scenario, and from text, voice to video. These data collecting, processing and usage operations are performed in a unified framework or a different framework.

Aspects of the present disclosure provide an OTA interferometer that enables transmitting by a source and redirecting by a RIS, to a destination, one or more reference signals over multiple time-frequency resources. In some embodiments, the time frequency resource are time slots allocated to transmission of reference signals between the source and destination. In each time-frequency resource, phases of one or more reference signals may be modified. Signal strength measurements may be made at the destination during the multiple time-frequency resources and used to determine a phase difference between the reference signals received at the destination. Examples of different types of source and destination may be devices such as a base station, an access point, a transmit receive point (TRP) and user equipment (UE). While specific examples utilizing an OTA interferometer are described below with a particular number of devices, types of communication (DL, UL, SL) and time-frequency resources (time slots) for particular applications, it should be noted that the concepts generally described herein can be used for different numbers of devices, types of communications, and time-frequency resources for other applications that may benefit from use of the proposed OTA interferometer.

In some embodiments, an OTA interferometer is provided that includes an RIS that is configured to enable a conventional RIS reflection channel between a source and destination in estimating the phase difference among RIS elements. In some embodiments this may enable AoA at the RIS and/or AoD at the RIS to be determined. In some embodiments, signaling methods to enable use of the OTA interferometer between a source and destination, such as a base station and a UE, via a RIS, are provided for both DL and UL transmission. In some embodiments, signaling methods to enable use of the OTA interferometer between a source and destination, such as a multiple UEs, via a RIS, are provided for SL transmission.

In some embodiments, an OTA interferometer may be used to enable coherent transmission over multiple paths between a source and destination. One example in which the OTA interferometer is used for coherent transmission involves the use of a transmitter, a receiver and multiple RIS, and considering that a signal arrives at the receiver via the RIS and also directly from the transmitter. Signaling may occur in either, or both, low and high frequency bands. Another example in which the OTA interferometer is used for coherent transmission involves, when the channel is frequency selective, using multiple narrow band RISs to allow coherent transmission in each band.

A further example in which the OTA interferometer is used for coherent transmission involves a relaying scheme where a relay device and a source device can coherently transmit signals to a destination device. Similar solutions may apply to other scenarios such as multi-TRP transmission and multi-node cooperative multiple input multiple output (MIMO) transmission.

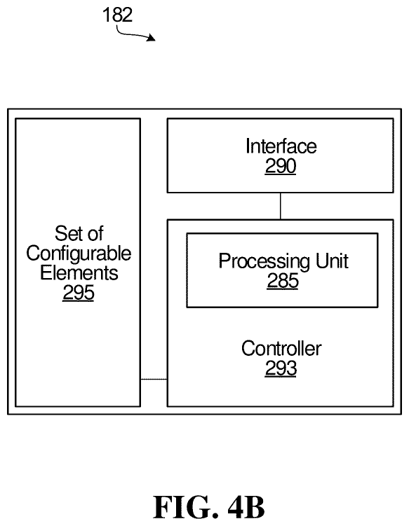

FIG. 6 illustrates a communication scenario in which source, such as a base station (BS) 610, communicates with a destination, such as UE 620, with help from a RIS 630. In a DL direction, the base station 610 transmits a reference signal in a direction of the RIS 630 for the RIS 630 to redirect the signal to the UE 620. The signal arriving at the RIS 630 is indicated to arrive at a particular angle of arrival (AoA). The signal that is redirected by the RIS 630 is indicated to depart at a particular angle of departure (AoD).

In order to improve and increase the signal strength at the UE 620, a phase-difference (ϕ_{d}) between two adjacent RIS elements should satisfy the equation 1 below:

$${ϕ}_{d} = \frac{2 π d}{λ} ( sin {θ}_{AoD} - sin {θ}_{AoA} ) \qquad ( 1 )$$

where d is space between two consecutive RIS elements, λ is the wavelength of the transmitted signal, θ_{AoD} is the angle of departure from the RIS to the UE with regard a direction normal to the surface of the RIS.

The phase difference may be estimated in order to be able to configure the RIS 630 to redirect the signal from the base station 610 to the UE 620. The OTA interferometer can be used to estimate the phase difference, and the phase difference may then be used to determine an improved estimate of the AoD for a signal leaving the RIS when the AoA is known, or vice versa.

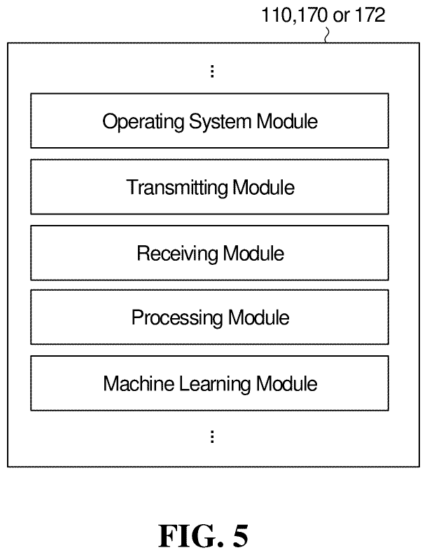

The OTA interferometer may be used in part to determine configuration information for the RIS. For example, a method may initially involve determining a course estimate of the phase difference via measurements, such as beam sweeping via wide beams between a source, the RIS, and a destination, or via sensing assisted information that may establish a rough location of the UE. For DL, the source is a base station and the destination is a UE. For UL, the source is a UE and the destination is a base station. For SL, DL, the source and destination are both UEs. As a part of the method, the base station, or a network that the base station is a part of, configures the RIS such that the RIS is virtually divided into two or more parts. FIG. 7A includes a base station (BS) 710, UE 720, and RIS 730 of length L. In FIG. 7A, the RIS 730 is divided into only two parts 732 and 734, where each part includes multiple RIS elements. The RIS 730 may be virtually divided into equal parts, as shown in FIG. 7A, or into non-equal parts. The phase-difference (ϕ_{d}) between two parts of the RIS satisfies equation (2) below, where L/2 is the spacing between the midpoints of the two equal sized parts of the RIS 730:

$${ϕ}_{d} = \frac{π L}{λ} ( sin {θ}_{AoD} - sin {θ}_{AoA} ) \qquad ( 2 )$$

A signal transmitted by the base station 710 that is redirected by each of the two parts 732 and 734 of the virtually divided RIS 730 appears as two signals with a phase difference (ϕ) as shown in FIG. 7A. The two signals may be considered to generally correspond to the two inputs S₁ and S₂ applied to the 6-port interferometer shown in FIG. 1.

In order to realize four outputs, the base station 710 transmits in four time slots as shown in FIG. 7B. In a first slot (Slot 1) the phases of the two parts first part 732 and second part 734 of the RIS 730 are not modified. In the second, third and fourth slots, (Slot 2, Slot 3 and Slot 4) the first part 732 of the RIS is not modified, but the second part 734 of the RIS 730 has a different additional phase component added in each slot such that the phase components of the second part 734 of the RIS 730 during each of the four slots are different from one another. The slots may be time slots or more generally separate time frequency resources.

With reference to the example of FIG. 7A, the RIS 730 is configured in each slot as follows:

In Slot 1, for both RIS parts 732 and 734, the phase shifts of the elements of the RIS 730 are the same. For example, if each part of the RIS 730 has four adjustable RIS elements and the phase difference between adjacent RIS elements is 20 degrees, and the first part 732 has elements having a phase of 20 degrees, 40 degrees, 60 degrees and 80 degrees, then the phases of the adjustable RIS elements of the second part 734 are likewise 20 degrees, 40 degrees, 60 degrees and 80 degrees as shown in FIG. 7C.

In Slot 2, the phases of RIS elements in the first part 732 are the same as in Slot 1, i.e., 20 degrees, 40 degrees, 60 degrees and 80 degrees. However, the phases of the elements in the second part 734 are increased by 90 degrees (i.e., 0.5π), i.e., 110 degrees, 130 degrees, 150 degrees and 170 degrees, as shown in FIG. 7D.

In Slot 3, the phases of RIS elements in the first part 732 are the same as in Slot 1. However, the phases of RIS elements in the second part 734 are increased by 180 degrees (i.e., π), i.e., 200 degrees, 220 degrees, 240 degrees and 260 degrees.

In Slot 4, the phases of RIS elements in the first part 732 are the same as in Slot 1. However, the phases of RIS elements in the second part 734 are increased by 270 degrees (i.e., 1.5π), i.e., 290 degrees, 310 degrees, 330 degrees and 350 degrees.

In order to determine the phase difference between the signals redirected by the first and second RIS parts 732 and 734, the UE 720 measures the received amplitude square or signal strength (SNR) in each slot and uses equation (3) as follows:

$$tan ϕ = \frac{{ρ}_{4} - {ρ}_{2}}{{ρ}_{1} - {ρ}_{3}} \qquad ( 3 )$$

where ρₖ for kϵ{1,2,3,4} is the amplitude square or the strength of the received signal in slot k while ϕ is the phase difference between the redirected signals from the first and second RIS parts 732 and 734 as shown in FIG. 7A. Examples of amplitude square or signal strength include one or more of SNR, reference signal received power (RSRP), and received signal strength indicator (RSSI). Then, by having determined ϕ and considering equation (2), it is possible to determine the AoD when the AoA is known, or the AoA when the AoD is known. By considering whether the values of ρ₄−ρ₂ and ρ₁−ρ₃ are positive, negative, or zero, the phase difference ϕ may be estimated in the range between −π and at, i.e. −π<ϕ<π. Otherwise, there may be ambiguity of the value of ϕ due to the 2π wrapping. However, such ambiguity may be resolved in several ways. For example, in some embodiments, when the AoA is known from the course estimation prior to use of the OTA interferometer (e.g. wide beam sweeping method), the AoD is expected to be within a beam width of the wide beam, i.e., the AoD has a specific range. Then, the beam used for the coarse estimate of the AoD may be such that within that beam width, the phase difference may be obtained without ambiguity and a more accurate AoD may be obtained from the phase difference.

Below is provided a discussion of the mean squared error (MSE) performance of the OTA interferometer when operated in a manner consistent with the example shown in FIGS. 7A, 7B, 7C and 7D.

The received superimposed signal at the UE 720 in each time slot is affected by additive white Gaussian noise (AWGN). Moreover, the base station 710 is considered to know the AoA at the RIS 730 because the base station 710, or the network, knows the location of the base station 710 and the RIS 730. Then, based on equation (3), the MSE for AoD from the RIS 730 can be expressed in equation (4) as follows:

$${MSE}_{{θ}_{AoD}} = E [ {( \hat{ϑ} - ϑ )}^{2} ] {( \frac{\partial ϑ}{\partial ϕ} \times \frac{\partial ϕ}{\partial {θ}_{AoD}} )}^{- 2} \qquad ( 4 )$$

$$where$$

$$ϑ = \frac{{ρ}_{4} - {ρ}_{2}}{{ρ}_{1} - {ρ}_{3}}$$

$$and$$

$$tan ϕ = ϑ .$$

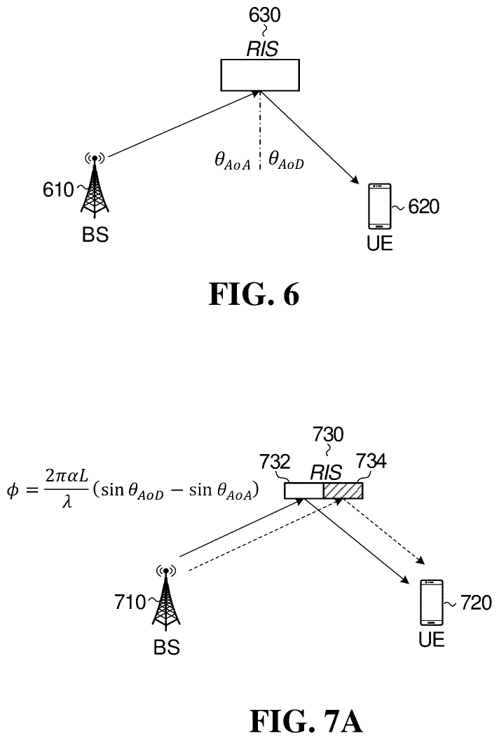

The MSE results can be obtained in decibels (dB) and the corresponding standard deviation in degrees from the RIS boresight (which is the direction perpendicular to the surface of the RIS, as shown in the two graphical plots in FIG. 8. For the plots in FIG. 8, the RIS length is 10λ, and SNRr=3 dB, where SNRr is the received SNR from one part of the RIS in one time slot. The plots show the standard deviation is less than 1.5 degrees for the AoD between 0 and 50 degrees (from the RIS boresight).

It is to be understood that use of the OTA interferometer described above can be implemented between any two nodes that are communicating using a RIS. Hence, it is applicable for UL and SL, in addition to DL as described in the above example.

Furthermore, while the method as described above assumes a linear (one dimensional (1D)) array of elements making up the RIS, it is considered to be straightforward to extend the method to an RIS having a 2 dimensional (2D) planar array. For example, while the method considers a 1D angle, such as AoA or AoD in an azimuth direction in 1D, and/or phase shift for 1D, the method can be applied to estimate elevation angles and/or phase shifts by dividing the RIS into two vertical parts. In some embodiments, the RIS may be virtually divided into two parts in a first direction at a first time to estimate angles or phase differences for the first direction and then virtually divided into two parts in a second direction at a second time to estimate angles or phase differences for the second direction More generally, the method can be adapted to other types of RIS structures.

It should be noted that various different mathematical functions may be used to estimate ϕ as long as the function utilizes the strength of the received signal from the different slots. For example, the inverse of equation (3) represents cot ϕ, which provides good performance when

$$\frac{{ρ}_{4} - {ρ}_{2}}{{ρ}_{1} - {ρ}_{3}} > 1 .$$

It should be also noted that if the channel (amplitude and phase) between the transmitter and the receiver is known at the receiver (e.g. the UE in DL), MSE performance may be improved by using coherent detection (e.g. minimum mean square error (MMSE) estimator or zero forcing (ZF) estimator from the received signals in the four time slots) instead of only relying on the amplitude square or the strength of the received signals in the four time slots. However, channel phase can be hard to track due to high Doppler effect, CFO mismatch, channel aging, phase noise, . . . etc. Hence, a non-coherent detector may be robust with respect to phase ambiguities while a coherent detector may not be robust with respect to phase ambiguities.

The order of the additional phase component in the four slots in the example of FIG. 7B is shown to increase from 0 in Slot 1 to 0.5π in Slot 2 to π in Slot 3 to 1.5π in Slot 4 and the phase is being changed in the second part 734 if the RIS 730 and not at all in the first slot 732 of the RIS 730. However, it is to be understood that the phase component that is added in the various slots and the particular RIS part to which additional phase is being added may be different than shown in FIG. 7B. For example, the phase component that is added in the various slots and/or the particular RIS part for which the phase is modified may be alternated provided that the received signals in the different slots can be appropriately utilized at the UE 720 to estimate the phase difference between the signals redirected by the RIS 730. Therefore, the UE 720 may be provided configuration information by the base station 710 that identifies which RIS part is being modified in a given slot, in addition to configuration information that identifies the size of the parts of the RIS 730.

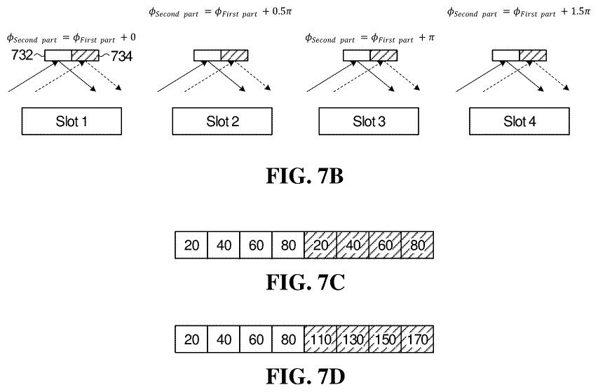

The example of FIGS. 7A and 7B illustrates the RIS 730 being virtually divided into two parts, the signal being transmitted over 4 time slots, and using 4 different phases in the second part of the RIS 730 (i.e., 0, 0.5π, π, 1.5π). It should be understood that alternative configurations may be used having different RIS virtual divisions and a different number of time slots transmissions with different added phases than with regard to what is shown in FIGS. 7A and 7B. For example, FIG. 9 illustrates how an RIS 930 is configured for use with the OTA interferometer in which transmission occurs over two time slots, Slot 1 and Slot 2, and the RIS 930 is virtually divided into four parts 912, 914, 916 and 918. In Slot 1, for all four parts 912, 914, 916 and 918, the phase shifts for are the same, i.e. ϕ_{second part}=ϕ_{First part}=ϕ_{Third part}=ϕ_{Fourth part}. In Slot 2, the phase of RIS elements in the first part 912 is the same as in Slot 1 and the phases of RIS elements in the second, third, and fourth parts 914, 916, and 918, are each increased by 180 degrees (i.e., π) as indicated by ϕ_{second part}=ϕ_{Third part}=ϕ_{Fourth part}=ϕ_{First part}+π, compared with those in the first part 912.

The phase difference between the signals reflected from two adjacent RIS parts, i.e. 912 and 914, may be determined from the strength of the received signals in Slot 1 and Slot 2 based on equation (5) below:

$${tan}^{2} 0.5 ϕ = \frac{{ρ}_{2}}{{ρ}_{1}} . \qquad ( 5 )$$

With reference to equation (5), the ambiguity of the 2π wrapping can be solved in a similar way that is described above for the previous OTA method (i.e. two part division of the RIS and four transmission at four time slots). However, even if −π<ϕ<π, there may be ambiguity regarding the sign of ϕ due to the square function in equation (5). Such ambiguity may be resolved in several ways. For example, in some embodiments, when AoD is to be estimated, two possible values of AoD can be estimated based on both positive and negative values of ϕ. By sending reference signals while updating the RIS based on the two possible values of the AoD, the destination (the UE in a DL scenario) may measure the strength of the received signals, feed back measurement information to the transmitter or feed back an index of the received signal with a highest signal strength, i.e. the AoD can be properly estimated.

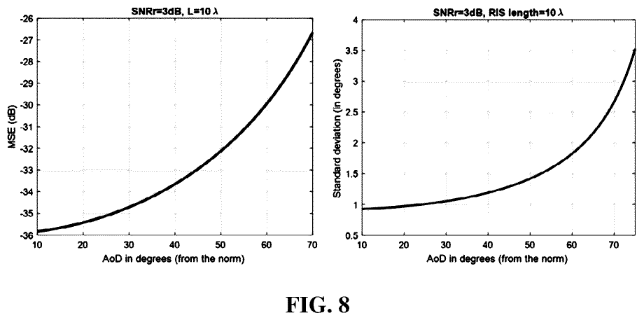

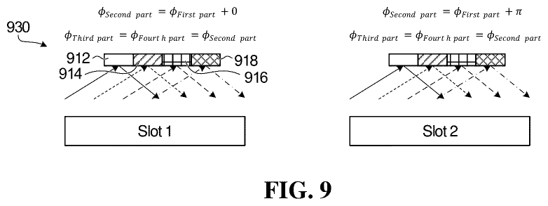

The following provides an example of signaling associated with using the OTA interferometer for DL transmission with reference to FIG. 10 and an example of signaling associated with using the OTA interferometer for UL transmission with reference to FIG. 11.

FIG. 10 is a signal flow diagram 1000 that illustrates signaling between a base station (BS) 1010, a UE 1020 and a RIS 1030 that enables operation of an OTA interferometer according to embodiments of the disclosure.

The base station 1010, or the network that the base station 1010 is a part of, may determine an angle of departure of a signal from the base station 1010 and/or an angle of arrival at the RIS 1030. Such information may be obtained by using sensing information that provides the UE location (with some ambiguity) or by using wide-beam sweeping measurements between the base station 1010, RIS 1030 and UE 1020.

At step 1040, when the base station 1010, or the network, knows the location of the base station 1010 and RIS 1030, the base station 1010 may beamform a signal in the direction of the RIS 1030 that includes configuration information for the RIS 1030 via radio resource control (RRC) signaling to redirect reference signals (RSS) in different directions (i.e., different AoDs from the RIS 1030) in a general direction of the UE 720. The configuration information may include information such as an angle of arrival (AoA) at the RIS of a beam the reference signal is transmitted on, an assumed angle of departure (AoD) at the RIS of the beam the reference signal is redirected and frequency information about the reference signal. An example of a type of reference signal for the DL direction may be channel state information reference signals (CSI-RS).

At step 1045, the base station 1010 may send configuration information to the UE 1020 to notify the UE 1020 about the reference signal, i.e. the type of reference signal being transmitted by the base station 1010, information used to identify the reference signal, information about the type of measurements the UE should make and what type of information should be fed back to the base station 1010. The base station 1010 may then send the reference signals that will be redirected in different directions by the RIS 1030 based on the configuration information the RIS 1020 received in step 1040. The UE 1020, while performing beam sweeping, performs measurements of the received reference signals (RS) based on the configuration sent to the UE 1020 by the base station 1010. Examples of the types of measurements made by the UE 1020 may include one or more of the signal strength, reference signal received power (RSRP), signal-to-noise (SNR), and received signal strength indicator (RSSI).

At step 1050, the UE 1020 feeds back information that identifies one or more reference signal with measurements that meet a threshold (e.g., signal strength is greater or equal a specific value). The information that identifies one or more reference signal may use a reference signal index value assigned to the reference signal beams to identify respective beams.

At step 1055, from the measurements received from the UE 1020, the base station 1010 determines a coarse AoD estimation. Based on the coarse AoD estimate, the base station 1010 may determine the phase difference between adjacent RIS elements to allow the RIS 1030 to redirect a signal to the UE 1020. The base station 1010 can then determine a preferred beam to send the RS to be used for the OTA interferometer. The beam may be associated with a particular index value used to identify the beam.

At step 1060, the base station 1010 sends to the UE 1020 higher layer signaling (e.g. RRC) that includes configuration information to enable use of the OTA interferometer between the base station 1010 and the UE 1020 via the RIS 1030. The OTA interferometer configuration information may include one or more of the following types of information: how many slots may be used for reference signal transmission (e.g. 4 slots in the 6-port interferometer described in the example of FIG. 7B); the type of signal measurement that should be performed at the UE 1020 and the type of feedback that should be provided by the UE 1020 for the received reference signals; and the type of function to be used for phase difference estimation, e.g., the ratio of the received signal strengths at different slots as in equation (3).

At step 1065, the base station 1010 sends to the RIS 1030 configuration information to enable the RIS 1030 to redirect beams in a manner that can be used to implements the OTA interferometer. The RIS configuration information may include one or more of the following types of information: phase shifts at RIS elements (e.g. phase difference between consecutive RIS elements) in different portions, how the RIS is virtually divided into multiple RIS parts (e.g. into two parts); and phases shifts of RIS elements in each of the virtually divided parts for each time slot.

At step 1070, the base station 1010 sends reference signals in each of multiple time slot that are redirected by the RIS 1030 to the UE 1020. The reference signals may be CSI-RS.

The UE 1020 then measures the signal strength and feeds back 1075 measurement information. The measurement information that is fed back may include one or more of: a signal strength of the measured reference signal in each time slot; and a ratio of the signal strengths among different time slots to help estimate the phase difference of the reference signals redirected by different RIS parts. If the channel (amplitude and phase) between the UE 1020 and base station 1010 is known at the UE 1020 in each time slot, the UE 1020 can estimate the phase difference between RIS parts and/or elements using other combination of the received signals (e.g. applying MMSE or ZF estimator).

At step 1080, the base station 1010, or the network, determines the phase difference between the reference signals based on the UE feedback received in step 1075. The phase difference information determined by the base station 1010 may then be used to determine a more accurate AoA for the RIS 1030 that results in an AoD at the RIS 1030 that provides a stronger signal arriving at the UE 1020. The phase difference information may be used to generate new updated RIS configuration information.

At step 1085, the base station 1010, or the network, sends the new updated RIS configuration information to the RIS 1030 that may be used to update AoD information or the phase difference between two RIS elements at RIS 1030 resulting in a more accurate redirection of the signal towards the UE 1020.

At step 1090, based on the RIS 1030 being updated with the updated RIS configuration information at step 1085, the base station 1010 and the UE 1020 may exchange data via the RIS 1030.

FIG. 11 is a signal flow diagram 1100 that illustrates signaling between a base station 1010, a US 1020 and a RIS 1030 that enables operation of an OTA interferometer according to embodiments of the disclosure. Some aspects of the UL signaling are similar to some aspects of the DL signaling shown in FIG. 10 and described above.

Step 1040 is substantially the same as described above with regard to FIG. 10. For the UL scenario in FIG. 11, at step 1040 the information for the RIS 1030 would be particular to the reference signals the UE 1020 will be sending, as opposed to the reference signals that the base station 1010 is sending in FIG. 10. As the UE 1020 is sending reference signals to the base station, the UE 1020 does not send measurement feedback as the base station performs measurements of the reference signals sent by the UE 1020.

At step 1145, the base station 1010 may send configuration information to the UE 1020 to notify the UE 1020 about the type of reference signal that should be transmitted by the UE 1020. An example of the type of reference signals sent by the UE 1020 may be a sounding reference signal (S-RS). The UE 1020 may then send the reference signals that will be redirected in different directions by the RIS 1030 based on the configuration information the RIS 1020 received in step 1040. The base station 1010, while performing beam sweeping, performs measurements of the received reference signals (RS). Examples of the types of measurements made by the base station 1010 may include one or more of the signal strength, reference signal received power (RSRP), signal-to-noise (SNR), and received signal strength indicator (RSSI).

At step 1155, the base station 1010 measures signal strength of reference signals transmitted by the UE 1020 and determines the AoD from the RIS 1030 of a signal received at the base station 1010 after being redirected from the RIS 1030 based on knowing the location of the base station 1010 and the RIS 1030. The base station 1010 can then determine a preferred beam to send the reference signal to be used for the OTA interferometer. The beam may be associated with a particular index value used to identify the beam.

At step 1160, the base station 1010 sends to the UE 1020 higher layer signaling (e.g. RRC) that includes configuration information to enable the OTA interferometer operating between the base station 1010 and the UE 1020 via the RIS 1030. The OTA interferometer configuration information may include an indication of how many slots may be used for reference signal transmission (e.g. 4 slot in the 6-port interferometer described in the example of FIG. 7B). In some embodiments, the configuration information may include an identification of the type of reference signal the UE 1020 should use. The type of reference signals sent by the UE 1020 may be an S-RS.

At step 1165, the base station 1010 sends configuration information to the RIS 1030 to configure the RIS 1030 to redirect signals from the UE 1020 to the base station 1010 assuming different angles of arrival at the RIS 1030 from the UE 1020. The RIS configuration information may include one or more of the following types of information: phase shifts at RIS elements (e.g. phase difference between consecutive RIS elements) in different portions, how the RIS is virtually divided into multiple RIS parts (e.g. into two parts); and phases shifts of RIS elements in each of the virtually divided parts for each time slot.

At step 1170, the UE 1020 sends reference signals in each time slot that are redirected by the RIS 1030 to the base station 1010.

At step 1175, the base station 1010 measures the amplitude square or strength of the received signals over multiple slots. From these measurements, the base station 1010 obtains fine AoA estimation at the RIS 1030 from the UE 1020 and can determine the phase difference between RIS elements. If the channel (amplitude and phase) between the base station 1010 and the UE 1020 is known at the BS 1010 in each time slot, the BS 1010 can estimate the phase difference between RIS elements and/or parts using other combination of the received signals (e.g. applying MMSE or ZF estimator).

At step 1180, the base station 1010, or the network, sends updated RIS configuration information to the RIS 1030 that includes updated AoA information or the phase difference between RIS elements at RIS 1030.

At step 1185, based on the RIS 1030 being updated with updated RIS configuration information at step 1085, the base station 1010 and the UE 1020 may exchange data via the RIS 1030.

It should be noted that generally, the information determined at the UE, either by measurement or determined based on the measurements (e.g. information may be one or more of the following: RSs strengths, SNR, RSSI, RSRP, beam index, functions of the RSs strengths, UE AoA in DL, AoD in UL, UE orientation, UE location) may be sent to the base station, or another network equipment, via an uplink control channel such as physical uplink control channel (PUCCH), physical uplink shared channel (PUSCH), or another uplink channel.

Information at the base station, which may be either measurements (e.g. RSs measurements) or determined based on the measurements, may be sent by the base station, or another network equipment, as well as configuration information (e.g. updated beam directions and beam-width at the UE) to a UE through a DL channel such as physical downlink control channel (PDCCH), MAC (media access control or medium access control) signaling, or other DL signaling. Moreover, the base station, or another network equipment, may use radio resource control (RRC) signaling for configuration such as: configuring a UE for reference signaling (e.g. CSI-RS in DL or SRS in UL), RIS redirection commands, interferometer parameters (reference signals in multiple time-slots, RIS division, portions or parts, . . . etc.) and other configurations for beam directions and beamwidths for different nodes, RIS location and size. Beam shape, antenna array pattern, number of antennas and other configuration information may be communicated through RRC signaling or UE category information.

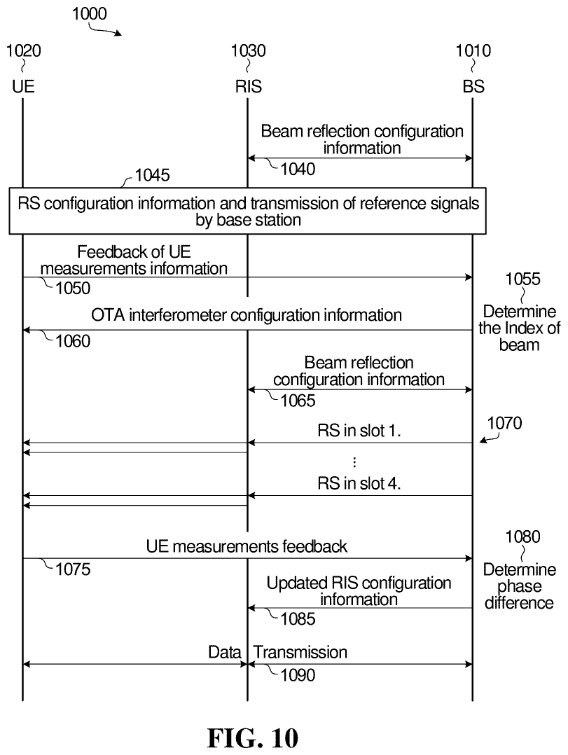

In some embodiments, the OTA interferometer may be used for other applications than the fine AoA/AOD estimation configuration described above. The following section describes how the OTA interferometer may help facilitate coherent transmission in various different communication scenarios. The OTA interferometer may be used to compensate a phase difference between signals traveling along multiple paths. For example, in some embodiments, multiple RIS can be used to achieve redirection to a destination as shown in FIG. 12A for multi-path coherent transmission. FIG. 12A illustrates an example of such a scenario that consists of a transmitter, such as base station (BS) 1210, a receiver, such as UE 1220, and two RISs, RIS, 1230 and RIS2 1232. The base station 1210 and UE 1220 may respectively transmit and receive over wide beams that allow the base station 1210 transmitted signals to reach both RISs RIS, 1230 and RIS2 1232 and be redirected and received by the UE 1220.

A multi-RIS coherent redirection may include performing fine AoA/AOD estimation configuration for each RIS. The fine AoA/AOD estimation configuration for each RIS may be as performed as described with regard to FIG. 10 or 11, or some other manner.

For coherent redirection using RIS, 1230 and RIS2 1232, the RISs in FIG. 12A may be deployed such that each RIS corresponds to one part of the virtually divided RIS 730 as shown in FIG. 7A.

Therefore, once the fine AoA/AOD estimation configuration is performed for each RIS 1230 and 1232, further steps may be performed over multiple slots, as shown in FIG. 12B, that may substantially correspond to what is described above with regard to FIGS. 7A, 7B, 7C and 7D, except that instead of the single RIS 730 being virtually divided into two parts 732 and 734, the two separate RISs 1230 and 1232 in FIG. 12B are used, and signals are sent by the base station 1210 over four slots.

In FIG. 12B, in Slot 1, for both RIS RIS1 1230 and RIS2 1232, the phase-shifts of the phase adjustable RIS elements of the two RISs are the same. For example, if each RIS has four elements and the phase difference between adjacent elements is 20 degrees, and RIS, 1230 has elements having a phase of 20 degrees, 40 degrees, 60 degrees and 80 degrees, then, the phases of the second RIS2 1232 are likewise 20 degrees, 40 degrees, 60 degrees and 80 degrees.

In Slot 2, the phases of RIS elements in RIS, 1230 are the same as in Slot 1, i.e., 20 degrees, 40 degrees, 60 degrees and 80 degrees. However, the phases of the elements in RIS2 1232 are increased by 90 degrees (i.e., 0.5π), i.e., 110 degrees, 130 degrees, 150 degrees and 170 degrees.

In Slot 3, the phases of elements of RIS 1 1230 are the same as in Slot 1. However, the phases of elements of RIS2 are increased by 180 degrees (i.e., π), i.e., 200 degrees, 220 degrees, 240 degrees and 260 degrees.

In Slot 4, the phases of elements of RIS, 1230 are the same as in Slot 1. However, the phases of elements of RIS2 1232 are increased by 270 degrees (i.e., 1.5π), i.e., 290 degrees, 310 degrees, 330 degrees and 350 degrees.

While it is described above that wide beams are used, it should be understood that narrow beams could also be used. While two RIS RIS1 1230 and RIS2 1032 are shown in FIGS. 12A and 12B, it is understood to be straight forward to extend the described concept to more than two RISs.

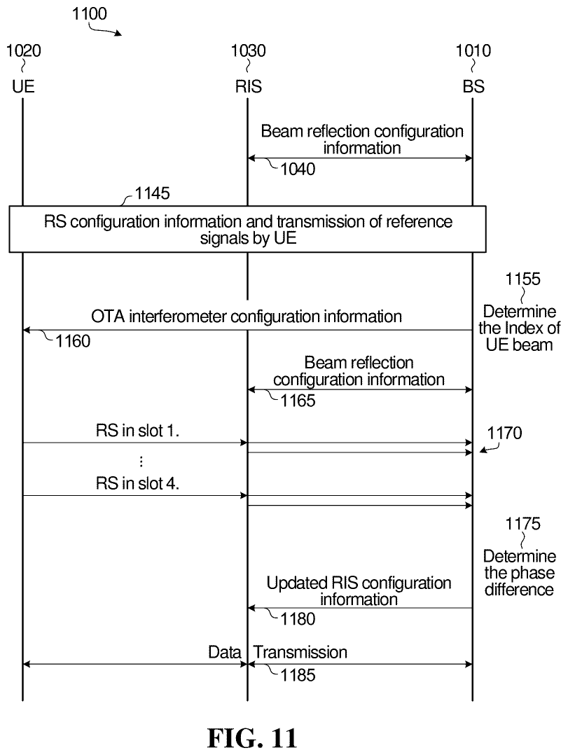

Another embodiment may include coherent transmission between the transmitter, such as base station (BS) 1310, and the receiver, such as UE 1320 and between the RIS 1330 and the UE 1320, as shown in FIG. 13. This scenario is similar to the coherent transmission scenario in FIG. 12A. However, this scenario considers the case when the receiver receives the source signal directly from the transmitter and via RIS redirection. In FIG. 13, use of the OTA interferometer may be similar to that of when a single RIS is virtually divided into two parts as shown in FIG. 7A, except where the base station 1310 in the case of FIG. 13 acts in a similar manner to the first RIS part 732 in FIG. 7A and the RIS 1330 in the case of FIG. 13 acts in a similar manner to the second RIS part 734 in FIG. 7A.

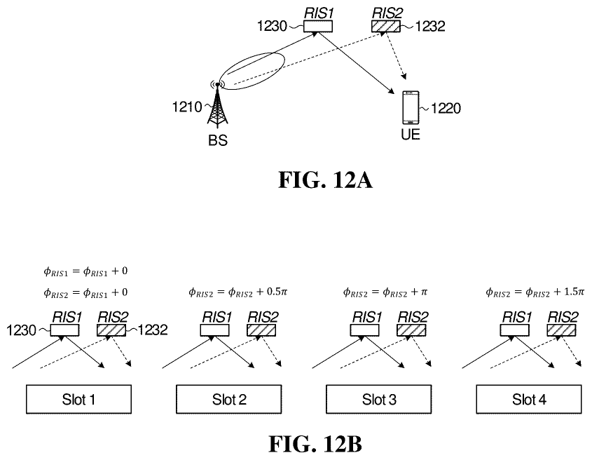

FIG. 14 shows another example of coherent transmission over a frequency selective channel between the transmitter, such as base station (BS) 1410, and the receiver, such as UE 1420 and between the multiple RISs 1430, 1432, 1434 and the UE 1420. The multiple RISs 1430, 1432, 1434 are each a narrow band RISs. Each RIS is effective for a different band and may be used to compensate a phase difference in each of the frequency selective bands by using the OTA interferometer in a similar way to that described for FIG. 13.

While the base station is indicated to be the transmitter and the UE to be the receiver in FIGS. 12A, 13 and 14 which result in a DL direction scenario, it is to be understood that the UE may be the transmitter and the base station may be the receiver for an UL direction scenario or the transmitter and receiver may be two UEs may be used for in a SL direction scenario.

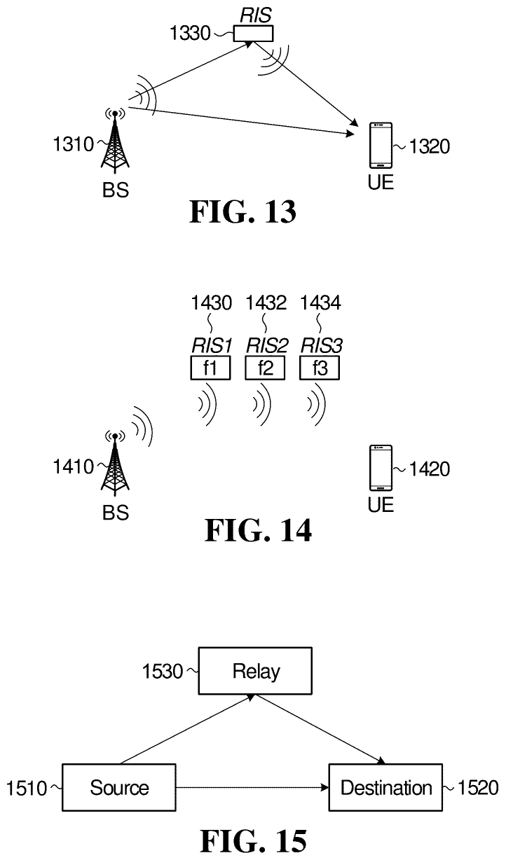

Another example of coherent transmission is coherent relaying as shown in FIG. 15. The coherent relaying is considered to be decode-forward (DF) relaying in which a relay receives a transmission, decodes the transmission and then forwards the transmission. FIG. 15 shows a first path for a source 1510 transmitting directly to a destination 1520 and a second path for the source 1510 transmitting to the destination 1520 via the relay 1530. The coherent DF relaying may be implemented with the help of the OTA interferometer described in this disclosure. To facilitate coherent relaying, the OTA interferometer may be used to estimate the phase difference between the direct line between the source 1510 and the destination 1520 and the relayed s to the destination.

For example, the OTA interferometer can be implemented as follows. The source and relay transmit four reference signals over four time slots. The reference signals may also be referred to as pilot signals. The same pilot signals can be repeated in each slot. In each slot, both the source and the relay transmit and the relay modifies the phases of the received signals in the different slots by {0, 0.5π. Π, 1.5π} before retransmitting the signals, while the source transmits without changing the phases. It may also be possible that the relay transmits a same phase signal while the source changes the phases in the different slots. The destination may estimate the phase difference based on the measured signal strengths in each time slot. The DF coherent relaying of data transmission between the source and destination may then be performed.

For an UL transmission scenario, where the destination is the base station and the source and relay may be two UEs (or other active nodes), the base station informs both UEs about the transmission over four time slots and phase changes.

For a DL transmission scenario, where the source and relay are transmit receive points (TRP) and the destination is a UE, the TRPs may coordinate transmission over four time slots and phase changes and request the destination (i.e., UE) to send the signal strength measured in the four time slots or a function of them (e.g. specific ratio) or other information that are related to the phase difference.

The OTA interferometer in embodiments described herein may provide an appropriate estimate for the phase between two signals.

The OTA interferometer in embodiments described herein may be used for fine RIS configuration, i.e., properly redirecting a signal to a destination. In some embodiments, use of the OTA interferometer may result in a high gain for the received signal.

The OTA interferometer in embodiments described herein may be robust against Doppler-shift and CFO considering the 6-port power ratio.

The OTA interferometer in embodiments described herein may simplify a receiver design as the interferometer is virtually moved OTA as being included in the receiver itself.

The OTA interferometer in embodiments described herein is flexible as it can be easily adapted to different types of interferometers (6-ports, two-ports, etc.). This is unlike including the interferometer at the receiver, which results in a fixed format of a specific interferometer.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
transmitting, by a base station, first configuration information, the first configuration information comprising relative phase difference information to apply to a plurality of portions of a reconfigurable intelligent surface (RIS) during each of a plurality of time slots;
during each of the plurality of time slots, transmitting, by the base station, reference signals that are redirected by the plurality of portions configured according to the first configuration information;
receiving, by the base station from a user equipment (UE), first measurement feedback information pertaining to the reference signals received at the UE after being redirected by the plurality of portions of the RIS over each of the plurality of time slots; and
determining, by the base station, updated RIS configuration information for a beam transmitted by the base station and redirected by the RIS based in part on the first measurement feedback information.

2. The method of claim 1, wherein the first configuration information comprises at least one of:
configuration information sent to the RIS for configuring the RIS; or
configuration information sent to the UE for configuring the UE.

3. The method of claim 2, wherein the first configuration information is the configuration information sent to the RIS and indicates at least one of:
phase shifts at RIS elements in different portions in the plurality of portions;
a number of portions in the plurality of portions;
a number of time slots in the plurality of time slots; or
phase shift information for use in phase shifting at least one of the plurality of portions with respect to at least one other portion in each time slot in the plurality of time slots.

4. The method of claim 2, wherein the first configuration information is the configuration information sent to the UE and indicates at least one of:
a number of time slots in the plurality of time slots;
a type of the reference signals transmitted by the base station;
a type of measurement to make at the UE;
a function to determine a phase difference estimate based on the reference signals; or
a type of information to be sent by the UE as the first measurement feedback information.

5. The method of claim 1, further comprising:
transmitting, by the base station, second configuration information, the second configuration information indicating identification of a plurality of beams, each beam of the plurality of beams having an associated direction, and the second configuration information further indicating identification of the reference signals on the plurality of beams;
transmitting, by the base station, the reference signals on the plurality of beams; and
receiving, by the base station, second measurement feedback information, the second measurement feedback information comprising measurement information pertaining to a channel on a link between the base station and the UE via redirection by the RIS or a channel on a link between the RIS and the UE, wherein the second measurement feedback information is used in part to determine the first configuration information.

6. A device at a side of a base station, comprising:
at least one processor; and
a computer-readable medium having stored thereon, computer executable instructions, that, when executed by the at least one processor, cause the device to perform operations including:
transmitting first configuration information, the first configuration information comprising relative phase difference information to apply to a plurality of portions of a reconfigurable intelligent surface (RIS) during each of a plurality of time slots;
during each of the plurality of time slots, transmitting reference signals that are redirected by the plurality of portions configured according to the first configuration information;
receiving, from a user equipment (UE), first measurement feedback information pertaining to the reference signals received at the UE after being redirected by the plurality of portions of the RIS over each of the plurality of time slots; and
determining updated RIS configuration information for a beam transmitted by the base station and redirected by the RIS based in part on the first measurement feedback information.

7. The device of claim 6, wherein the first configuration information comprises at least one of:
configuration information sent to the RIS for configuring the RIS; or
configuration information sent to the UE for configuring the UE.

8. The device of claim 7, wherein the first configuration information is the configuration information sent to the RIS and indicates at least one of:
phase shifts at RIS elements in different portions in the plurality of portions;
a number of portions in the plurality of portions;
a number of time slots in the plurality of time slots; or
phase shift information for use in phase shifting at least one of the plurality of portions with respect to at least one other portion in each time slot in the plurality of time slots.

9. The device of claim 7, wherein the first configuration information is the configuration information sent to the UE and indicates at least one of:
a number of time slots in the plurality of time slots;
a type of the reference signals transmitted by the base station;
a type of measurement to make at the UE;
a function to determine a phase difference estimate based on the reference signals; or
a type of information to be sent by the UE as the first measurement feedback information.

10. The device of claim 6, the operations further comprising:
transmitting second configuration information, the second configuration information indicating identification of a plurality of beams, each beam of the plurality of beams having an associated direction, and the second configuration information further indicating identification of the reference signals on the plurality of beams;
transmitting the reference signals on the plurality of beams; and
receiving second measurement feedback information, the second measurement feedback information comprising measurement information pertaining to a channel on a link between the base station and the UE via redirection by the RIS or a channel on a link between the RIS and the UE, wherein the second measurement feedback information is used in part to determine the first configuration information.

11. A method comprising:
receiving, by a user equipment (UE), first configuration information;
during each of a plurality of time slots, receiving, by the UE, reference signals that are redirected by a plurality of portions of a reconfigurable intelligent surface (RIS), wherein, during the plurality of time slots there is a relative phase difference applied to the plurality of portions during each of the plurality of time slots;
measuring, by the UE, signal strength of the reference signals received at the UE during each of the plurality of time slots; and
transmitting, by the UE, first measurement feedback information to a base station, the first measurement feedback information based upon the signal strength of the reference signals received at the UE after being redirected by the plurality of portions over each of the plurality of time slots.

12. The method of claim 11, wherein the first configuration information indicates at least one of:
a number of portions in the plurality of portions;
a number of time slots in the plurality of time slots;
phase shift information for use in phase shifting at least one of the plurality of portions with respect to at least one other portion in each time slot in the plurality of time slots;
a type of the reference signals transmitted by the base station;
a type of measurement to make at the UE;
a function to determine a phase difference estimate at the UE based on the reference signals; or
a type of information to be sent by the UE as the first measurement feedback information.

13. The method of claim 11, further comprising:
receiving, by the UE, second configuration information, the second configuration information indicating identification of a plurality of beams, each beam of the plurality of beams having an associated direction, and the second configuration information further indicating identification of reference signals on the plurality of beams;
receiving, by the UE, the reference signals on the plurality of beams; and
transmitting, by the UE, second measurement feedback information, the second measurement feedback information comprising measurement information pertaining to a channel on a link between the UE and the base station via redirection by the RIS or a channel on a link between the RIS and the UE, wherein the second measurement feedback information is used in part to determine the first configuration information.

14. The method of claim 11, wherein the first measurement feedback information comprises one or more of:
signal strength measurements of the reference signals in each of the plurality of time slots;
a function based on signal strength measurements of the reference signals in each of the plurality of time slots;
channel phases of the reference signals in each of the plurality of time slots; or
phase difference information between the reference signals redirected by different RIS portions, determined based on the signal strength measurements of the reference signals in each of the plurality of time slots or other combination of the reference signals of the plurality of time slots.

15. The method of claim 11, further comprising:
receiving data that has been redirected by the RIS or transmitting data to be redirected by the RIS based at least in part on the first measurement feedback information.

16. A device at a side of a user equipment (UE) comprising:
at least one processor; and
a computer-readable medium having stored thereon, computer executable instructions, that, when executed by the at least one processor, cause the device to perform operations including:
receiving first configuration information;
during each of a plurality of time slots, receiving reference signals that are redirected by a plurality of portions of a reconfigurable intelligent surface (RIS), wherein during the plurality of time slots there is a relative phase difference applied to the plurality of portions during each of the plurality of time slots;
measuring signal strength of the reference signals received at the UE during each of the plurality of time slots; and
transmitting first measurement feedback information to a base station, the first measurement feedback information based upon the signal strength of the reference signals received at the UE after being redirected by the plurality of portions over each of the plurality of time slots.

17. The device of claim 16, wherein the first configuration information indicates at least one of:
a number of portions in the plurality of portions;
a number of time slots in the plurality of time slots;
phase shift information for use in phase shifting at least one of the plurality of portions with respect to at least one other portion in each time slot in the plurality of time slots;
a type of the reference signals transmitted by the base station;
a type of measurement to make at the UE;
a function to determine a phase difference estimate at the UE based on the reference signals; or
a type of information to be sent by the UE as the first measurement feedback information.

18. The device of claim 16, the operations further comprising:
receiving second configuration information, the second configuration information indicating identification of a plurality of beams, each beam of the plurality of beams having an associated direction, and the second configuration information further indicating identification of reference signals on the plurality of beams;
receiving the reference signals on the plurality of beams; and
transmitting second measurement feedback information, the second measurement feedback information comprising measurement information pertaining to a channel on a link between the UE and the base station via redirection by the RIS or a channel on a link between the RIS and the UE, wherein the second measurement feedback information is used in part to determine the first configuration information.

19. The device of claim 16, wherein the first measurement feedback information comprises one or more of:
signal strength measurements of the reference signals in each of the plurality of time slots;
a function based on signal strength measurements of the reference signals in each of the plurality of time slots;
channel phases of the reference signals in each of the plurality of time slots; or
phase difference information between the reference signals redirected by different RIS portions, determined based on the signal strength measurements of the reference signals in each of the plurality of time slots or other combination of the reference signals of the plurality of time slots.

20. The device of claim 16, the operations further comprising:
receiving data that has been redirected by the RIS or transmitting data to be redirected by the RIS based at least in part on the first measurement feedback information.
